(19) United States
(12) Patent Application Publication
(10) Pub. No.: US 2017/0136346 A1
(43) Pub. Date: May 18, 2017

(54) Interaction Method, Interaction Apparatus and User Equipment

(71) Applicant: Beijing Zhigu Rui Tuo Tech Co., Ltd, Beijing (CN)

(72) Inventor: Zhengxiang WANG, Beijing (CN)

(21) Appl. No.: 15/313,442

(22) PCT Filed: Apr. 30, 2015
(86) PCT No.: PCT/CN2015/077946

§ 371 Date: Nov. 22, 2016

(30) Foreign Application Priority Data
May 23, 2014 (CN) 201410222863.3

(51) Int. Cl. A63F 13/211; G06T 11/60; A63F 13/92; G06F 3/01; A63F 13/803; A63F 13/837

(52) U.S. Cl. CPC A63F 13/211; A63F 13/803; A63F 13/837; A63F 13/92; G06F 3/011; G06T 11/60; A63F 2300/8017; A63F 2300/8076; A63F 2300/8082; A63F 2300/204; A63F 2300/203; A63F 2300/105

(57) ABSTRACT

Embodiments of the present application provide an interaction method and an interaction apparatus, and the method comprises: acquiring first movement information of a mobile carrier that at least one user rides on; and determining, in real time according to the first movement information, second movement information of a virtual mobile carrier that at least one character corresponding to the at least one user rides on in a virtual scene. In the technical solution of the embodiments of the present application, a virtual scene that a user is experiencing is combined with inertia that the user feels when riding on a mobile carrier such as a vehicle, which can help the user obtain four-dimensional entertainment experience by using the mobile carrier ridden and the virtual scene.

### RELATED APPLICATION

The present international patent cooperative treaty (PCT) application claims the benefit of priority to Chinese Patent Application No. 201410222863.3, filed on May 23, 2014, and entitled “Interaction Method and Interaction Apparatus”, which is hereby incorporated into the present international PCT application by reference herein in its entirety.

### TECHNICAL FIELD

The present application relates to interaction technologies, and in more particular, to an interaction method and an interaction apparatus.

### BACKGROUND

Four-dimensional movies or four-dimensional game technologies combine vibration, blow, water spray, mist, bubbles, odor, scenery and other environment effects with three-dimensional stereo display, to give users physical stimulation associated with content of movies or games and let the users feel more realistic when they watch the movies or play the games, which enhances the sense of telepresence for the users. Motion experience in the four-dimensional movies or four-dimensional games, for example, swinging left and right, bending forward and backward, and rotation and other motion effects, is often predefined during compilation, and can be implemented only by using specialized devices; therefore, the users generally can only go to four-dimensional cinemas or theme park rides to experience the effects.

### SUMMARY

An example, non-limiting object of the present application is to provide an interaction solution.

According to a first example aspect, the present application provides an interaction method, comprising:

acquiring first movement information of a mobile carrier that at least one user rides on; and

determining, in real time according to the first movement information, second movement information of a virtual mobile carrier that at least one character corresponding to the at least one user in a virtual scene rides on.

According to a second example aspect, the present application provides an interaction apparatus, comprising:

a movement information acquiring module, configured to acquire first movement information of a mobile carrier that at least one user rides on; and

a processing module, configured to determine, in real time according to the first movement information, second movement information of a virtual mobile carrier that at least one character corresponding to the at least one user in a virtual scene rides on.

According to a third example aspect, the present application provides a user equipment comprising the interaction apparatus mentioned above.

According to a fourth example aspect, the present application provides a computer readable storage device comprising executable instructions that, in response to execution, cause a device comprising a processor to perform operations, comprising:

acquiring first movement information of a mobile carrier that at least one user rides on; and

determining, in real time according to the first movement information, second movement information of a virtual mobile carrier that at least one character corresponding to the at least one user in a virtual scene rides on.

In at least one technical solution of example embodiments of the present application, a virtual scene that a user is experiencing is combined with inertia that the user feels when riding on a mobile carrier such as a vehicle, which can help the user obtain four-dimensional entertainment experience by using the mobile carrier ridden and the virtual scene.

### BRIEF DESCRIPTION OF THE DRAWINGS

FIG. 1 is a flowchart of an interaction method according to an example embodiment of the present application;

FIG. 2 is a schematic structural diagram of an interaction apparatus according to an example embodiment of the present application;

FIG. 3a to FIG. 3c are schematic structural diagrams of another three interaction apparatuses according to example embodiments of the present application;

FIG. 4 is a schematic structural diagram of a user equipment according to an example embodiment of the present application; and

FIG. 5 is a schematic structural diagram of another interaction apparatus according to an example embodiment of the present application.

### DETAILED DESCRIPTION

Example embodiments of the present application are described in detail hereinafter with reference to the accompanying drawings (the same reference numerals in several drawings indicate the same elements) and embodiments. The following embodiments are used for describing the present application, but not intended to limit the scope of the present application.

A person skilled in the art should understand that, the terms such as “first” and “second” in the present application are only used to distinguish different steps, devices or modules, and neither represent any specific technical meaning nor represent a necessary logical order between them.

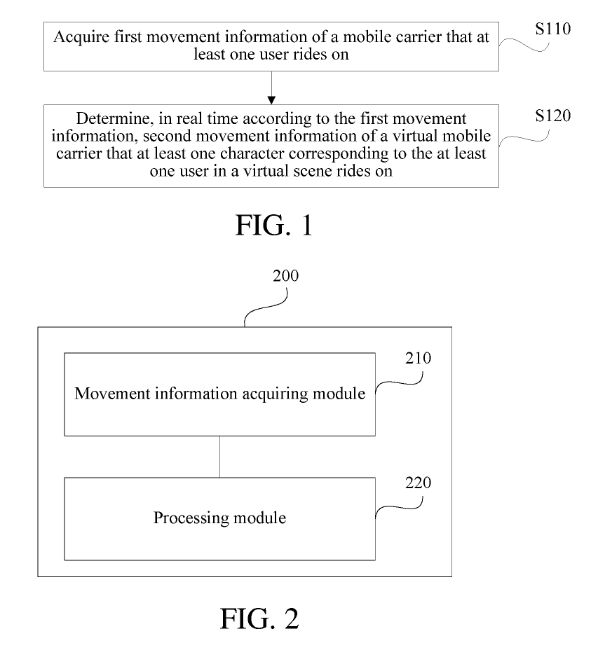

As shown in FIG. 1, an embodiment of the present application provides an interaction method, comprising:

S110: Acquire first movement information of a mobile carrier that at least one user rides on.

S120: Determine, in real time according to the first movement information, second movement information of a virtual mobile carrier that at least one character corresponding to the at least one user in a virtual scene rides on.

For example, an interaction apparatus provided in the present application serves as an entity for executing this embodiment, to perform S110 and S120. Specifically, the interaction apparatus may be disposed in a user equipment in the form of software, hardware or a combination thereof, or the interaction apparatus is the user equipment; the user equipment comprises, but is not limited to: smart glasses, a smart helmet, and other immersive display devices, where the smart glasses are classified into smart eyeglasses and smart contact lenses; a smart phone, a tablet computer and other portable smart devices; and an entertainment device on the mobile carrier.

In this embodiment of the present application, the mobile carrier is a carrier that carries the user to move, which, for example, may be a car, a subway, a boat, an aircraft and other means of transportation.

In this embodiment of the present application, the virtual mobile carrier is a carrier that carries the character of the user in the virtual scene to move, for example, an aircraft, a car, a starship, and clouds in the virtual scene.

In this embodiment of the present application, the at least one user may be one user, or may be multiple users riding on the same mobile carrier. In the case of multiple users, when ridding on the mobile carrier, the multiple users may play the same game while being interconnected, for example, multiple characters corresponding to the multiple users respectively ride on the same virtual mobile carrier in the same game and interact with each other. The following embodiments of the present application are described by using an example in which the at least one user is one user.

In this embodiment of the present application, the user is a passenger on the mobile carrier (rather than a driver, and the user cannot actively change the movement of the mobile carrier), and will feel the corresponding inertia when the mobile carrier accelerates, decelerates or makes a turn. For example, the body of the passenger will passively lean back, lean forward, lean left and right as the mobile carrier accelerates, decelerates, makes a turn, and runs uphill and downhill.

In this embodiment of the present application, the term “in real time” means being within a short time interval, for example a preset time interval. In this embodiment of the present application, the time interval corresponding to the real time, for example, may be: a processing time in which the processing module processes and obtains the second movement information according to the first movement information. According to the performance of the processing module, the processing time is generally very short, and the user hardly feels a delay. In this embodiment of the present application, the second movement information is determined in real time according to the first movement information, to obtain a corresponding virtual scene, so that the user can see or hear the corresponding virtual scene almost without noticing a delay when the user feels the inertia corresponding to the first movement information, and the user combines the virtual scene with the feeling of inertia brought about by the mobile carrier, to obtain better entertainment effects.

The steps of the method in this embodiment of the present application are further described below with reference to the following example embodiments:

S110: Acquire first movement information of a mobile carrier that at least one user rides on.

In this embodiment of the present application, the first movement information is also acquired in real time. That is, the first movement information of the mobile carrier is acquired in such a time interval that the user hardly feels a delay.

In this embodiment of the present application, the first movement information comprises first acceleration information, and the first acceleration information herein comprises acceleration direction information and magnitude information. For example, when the mobile carrier accelerates forward on a flat ground, the first acceleration information is acceleration in a forward direction; when the mobile carrier falls down from a high place, the first acceleration information comprises downward acceleration, causing the user to feel the inertia of weightlessness. Certainly, when the mobile carrier makes a turn, acceleration with a lateral component may be generated, causing the user to feel the inertia of centrifugation.

In this embodiment of the present application, the first movement information further comprises: first speed information. Herein, the first speed information comprises speed direction information and magnitude information.

In this embodiment of the present application, the first movement information further comprises: first posture information. In one example embodiment, when the mobile carrier runs uphill, downhill or on a slope with a high side and a low side (for example, the left side is high and the right side is low), the posture of the user in the mobile carrier may change correspondingly, and therefore, the user has a feeling corresponding to the posture of the mobile carrier. For example, when the mobile carrier runs on the slope, the user correspondingly has a feeling of leaning towards the lower side.

Certainly, in some embodiments, the first movement information may only comprise the first acceleration information. Alternatively, in addition to the first acceleration information, the first movement information further comprises one of the first speed information and the first posture information.

In one example embodiment of this embodiment of the present application, the first movement information may be acquired in many manners, for example:

1) The first movement information is collected.

For example: the first movement information is collected by a movement sensor module disposed on the interaction apparatus.

2) The first movement information is received from at least one external device.

In one example embodiment, the at least one external device, for example, may be the mobile carrier. When a car, an aircraft or another means of transportation serves as the mobile carrier, because these means of transportation are provided with a movement sensor module that collects the first movement information, the first movement information collected by the movement sensor module on the means of transportation can be used.

In another example embodiment, the at least one external device, for example, may also be another portable device of the user. For example, a movement sensor device specifically used to acquire the first movement information, or a portable device such as a smart phone or smart watch having a movement sensor module.

In this case, the interaction apparatus is provided with a communication module communicating with the at least one external device, to receive the first movement information from the at least one external device.

S120: Determine, in real time according to the first movement information, second movement information of a virtual mobile carrier that at least one character corresponding to the at least one user in a virtual scene rides on.

In this embodiment of the present application, the virtual scene is an immersive virtual scene, and the virtual scene is a game scene. For example, the user experiences the immersive virtual scene through smart glasses or a smart helmet. Herein, the immersive virtual scene refers to a scene that provides participants with fully immersive experience, to make the users feel like in a virtual world. For example, common immersive systems comprise systems based on a helmet display and projection virtual reality systems.

In this embodiment of the present application, corresponding to the first movement information, the second movement information comprises: second acceleration information.

In this embodiment of the present application, the second movement information may further comprise: second speed information and second posture information.

Similarly, the second acceleration information comprises the magnitude and direction of acceleration, and the second speed information comprises the magnitude and direction of a speed.

Certainly, in some embodiments, corresponding to the first movement information, the second movement information may only comprise the second acceleration information. Alternatively, in addition to the second acceleration information, the second movement information further comprises one of the second speed information and the second posture information.

In this embodiment of the present application, when the second movement information is determined according to the first movement information:

it may be determined that the second movement information is the same as the first movement information, for example, when the mobile carrier is at a speed of 60 km/h, it is determined that the virtual mobile carrier is also at a speed of 60 km/h in the virtual scene; or

the first movement information may be amplified or reduced in a predetermined manner, to obtain the second movement information, for example, when the mobile carrier is a car and the virtual mobile carrier is an aircraft, the speed and acceleration of the car are amplified ten times to obtain the speed and acceleration of the virtual mobile carrier. For another example, the second movement information may be obtained by increasing or decreasing a predetermined reference value on the basis of the first movement information, for example, when both the mobile carrier and the virtual mobile carrier are cars, the speed of the virtual mobile carrier may be the speed of the mobile carrier plus 20 km/h, and in this way, even if the mobile carrier stops, the virtual mobile carrier still runs at a constant speed of 20 km/h. For another example, when the mobile carrier runs on an upslope of 20 degrees, the second posture information of the virtual mobile carrier may correspond to the virtual mobile carrier runs on an upslope of 30 degrees.

It can be seen from the above that the relationship between the second movement information and the first movement information may be determined according to design requirements of the virtual scene.

In one example embodiment, the environment of the virtual scene is unchanged, and only movement of the virtual mobile carrier changes. For example, the character corresponding to the user rides in a spacecraft to travel in space, and the background of the virtual scene may always be empty space. In another example embodiment, when the second movement information of the virtual movement carrier changes, the virtual scene also is to change correspondingly, so as to bring about more realistic experience to the user. Therefore, the method further comprises:

determining scene information of the virtual scene corresponding to the second movement information.

For example, when it is determined that the second movement information implicates an upward acceleration component, an upslope may appear in front of the virtual mobile carrier in the virtual scene.

To further bring about more realistic entertainment experience to the user, in the process of determining the virtual scene, in addition to the second movement information, state information of the user with respect to the mobile carrier may also be considered; therefore, optionally, in one example embodiment, the method further comprises:

acquiring state information of the at least one user with respect to the mobile carrier.

The determining a virtual scene corresponding to the second movement information is further:

determining scene information of the virtual scene corresponding to the state information and the second movement information.

Herein, the state information may comprise: posture information and/or safety belt usage information. The posture information, for example, may be: the posture information indicating that the user stands, sits or lies in the mobile carrier. For example, when the user stands in a compartment of a car, the character of the user may also stand in the virtual mobile carrier. In addition, for example, when the user uses the safety belt, the character of the user may also use the safety belt in the virtual mobile carrier.

In the embodiment of the present application, the scene information comprises:

display information and sound information.

For example, when the mobile carrier suddenly brakes, the virtual mobile carrier may also suddenly brake in the virtual scene, and an environmental scene where a rock falls may appear in front of the virtual mobile carrier, and in addition, there may be sound corresponding to the sudden braking and the falling of the rock.

In one example embodiment, the interaction apparatus corresponding to the method in this embodiment of the present application comprises, for example, presentation modules such as a display screen and a loudspeaker, and at this time, the method further comprises:

presenting the virtual scene according to the scene information.

Herein, the presentation comprises: displaying visual content corresponding to the display information, and playing audio content corresponding to the sound information.

In another example embodiment, the virtual scene can be presented by a presentation module of another device, and at this time, the method further comprises:

providing the scene information to at least one external device.

For example, the interaction apparatus may be a smart phone of the user, which, after the scene information is determined, provides the scene information to another presentation device of the user, such as smart glasses of the user, and the smart glasses present the virtual scene for the user.

In a further example embodiment, the interaction apparatus corresponding to the method in this embodiment of the present application is only used for acquiring the second movement information, while determining and presentation of the virtual scene are performed by other devices, and in this example embodiment, the method further comprises: providing the second movement information to at least one external device.

Several application scenes of this embodiment of the present application are given below to further describe this embodiment of the present application.

In one possible scene, a user rides on a car to play a shooting game, and the character manipulated by the user rides in a first fighter to shoot at least one second fighter of the enemy in the game. In this embodiment, the mobile carrier is the car that the user is riding on currently, the virtual scene is the shooting game, and the virtual mobile carrier is the first fighter.

In this example embodiment, after acceleration, speed and posture information of the car are acquired in real time, acceleration, speed and posture information of the first fighter in the background of the shooting game are obtained in real time through computing. Moreover, when second movement information of the first fighter changes with the first movement information of the car, the scene in the shooting game changes accordingly. That is, the speed and direction of the first fighter and a scene graph of a virtual sky are determined in real time according to a running state of the car that the user actually rides on. For example, when the car makes a turn, due to inertia, the passenger can feel that the car is making a turn, and at the same time, sees that the first fighter in the virtual scene is also making a turn, and that the corresponding virtual sky and the position of the enemy fighter also change, where a change in direction of the fighter in the virtual scene is kept the same as a change in direction when the car makes a turn, and the user can hit a target effectively only by changing an aiming direction for shooting and bullet firing frequency thereof according to the change.

In another possible scene, the user passenger only experiences a four-dimensional game, and it is unnecessary to input operation information (for example, operation information of aiming and firing bullets) like the above shooting game. For example, the user rides in a steamship to play an experiential game of floating in the sea, where the mobile carrier is the steamship, the virtual scene is a scene of floating in the sea, and the character corresponding to the user rides in a drifting boat to drift along, to see various sea sceneries on the way. When a first movement information of the steamship changes, the second movement information of the drifting boat and a corresponding virtual environment, such as sea waves, also change in real time. For example, in an actual environment, when the steamship drifts up and down with a wave, a wave also appears in the virtual environment, and the drifting boat also drifts up and down, so that actual four-dimensional experience of the user corresponds to the scene in the game, bringing about better four-dimensional game experience to the user.

A person skilled in the art should understand that, in the method of the example embodiment of the present application, sequence numbers of the steps do not indicate order of execution, the order in which the steps are executed should be determined according to functions and internal logic thereof, but should not constitute any limitation to an implementation process of the example embodiment of the present application.

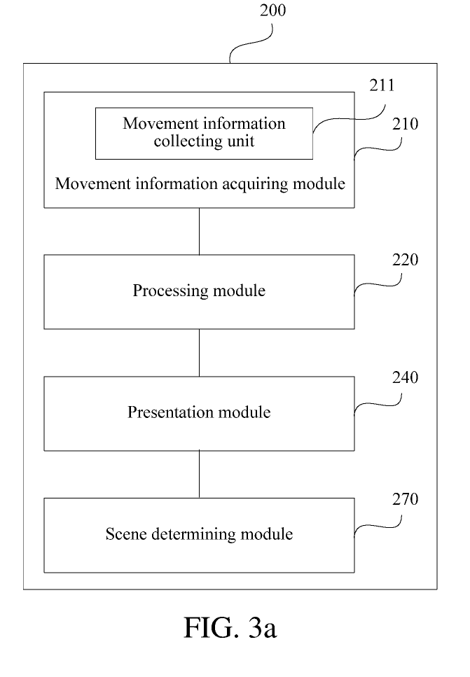

As shown in FIG. 2, an interaction apparatus 200 comprises:

a movement information acquiring module 210, configured to acquire first movement information of a mobile carrier that at least one user rides on; and

a processing module 220, configured to determine, in real time according to the first movement information, second movement information of a virtual mobile carrier that at least one character corresponding to the at least one user in a virtual scene rides on.

In this embodiment of the present application, the mobile carrier is a carrier that carries the user to move; the virtual mobile carrier is a carrier that carries the character of the user in the virtual scene to move; the at least one user may be one user, or may be multiple users riding on the same mobile carrier. Refer to the corresponding description in the foregoing method embodiment for further description about the mobile carrier, the virtual mobile carrier and the at least one user.

In this embodiment of the present application, the determining, in real time according to the first movement information, the second movement information means: determining, within a time interval that a user hardly notices, the second movement information according to the first movement information; refer to the corresponding description in the foregoing method embodiment for details.

In this embodiment of the present application, the second movement information is determined in real time according to the first movement information, to obtain a corresponding virtual scene, so that the user can see or hear the corresponding virtual scene almost without noticing a delay when the user feels the inertia corresponding to the first movement information, and the user combines the virtual scene with the inertia feeling brought about by the mobile carrier, to obtain four-dimensional entertainment effects without going to special four-dimensional cinemas or four-dimensional game places.

In this embodiment of the present application, the movement information acquiring module acquires the first movement information in real time, which comprises acquiring the first movement information in a predetermined short period (for example, the period is less than 5 ms).

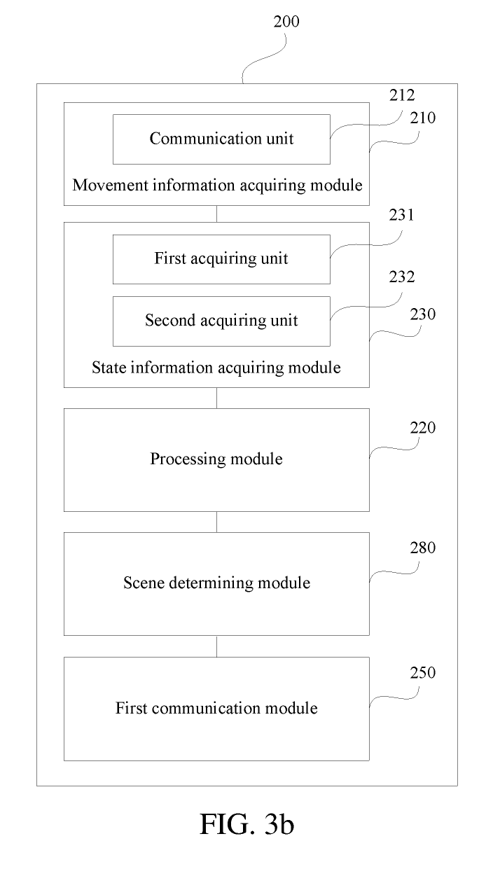

As shown in FIG. 3a, in one example embodiment, the interaction apparatus 200 collects the first movement information, for example, the movement information acquiring module 210 may comprise:

a movement information collecting unit 211, configured to collect the first movement information.

In this embodiment of the present application, the first movement information comprises: first acceleration information.

In this case, the movement information collecting unit 211 may comprise an acceleration sensor, configured to collect the first acceleration information of the mobile carrier. The acceleration sensor, for example, may comprise: a gyroscope, or a linear accelerometer and so on.

In this embodiment of the present application, the first movement information may further comprise:

first speed information.

In this case, the movement information collecting unit 211 may comprise a speed sensor, configured to collect the first speed information of the mobile carrier. The speed sensor, for example, may comprise: a vehicle speed sensor.

In this embodiment of the present application, the first movement information may further comprise:

first posture information.

In this case, the movement information collecting unit 211 may comprise a posture sensor, configured to collect the first posture information of the mobile carrier.

Refer to corresponding content in the foregoing method embodiment for further description about the first acceleration information, the first speed information and the first posture information.

Certainly, in some embodiments, the first movement information may only comprise the first acceleration information. Alternatively, in addition to the first acceleration information, the first movement information further comprises one of the first speed information and the first posture information. Therefore, the movement information collecting unit 211 may also only comprise one or more corresponding sensor(s).

In another possible implementation, as shown in FIG. 3b, the interaction apparatus 200 acquires the first movement information from at least one external device, for example, the movement information acquiring module 210 comprises:

a communication unit 212, configured to receive the first movement information from the at least one external device.

In one example embodiment, the at least one external device, for example, may be the mobile carrier. When a car, an aircraft or another means of transportation serves as the mobile carrier, because these means of transportation are provided with a movement sensor module that collects the first movement information, the first movement information collected by the movement sensor module on the means of transportation can be used.

In another example embodiment, the at least one external device, for example, may be another portable device of the user. For example, a movement sensor device specifically used to acquire the first movement information, or a portable device such as a smart phone or smart watch having a movement sensor module.

In this embodiment of the present application, the virtual scene is an immersive virtual scene, and the virtual scene is a game scene. For example, the user experiences the immersive virtual scene through smart glasses or a smart helmet.

In this embodiment of the present application, corresponding to the first movement information, the second movement information comprises: second acceleration information.

In this embodiment of the present application, the second movement information may further comprise: second speed information and second posture information.

Similarly, the second acceleration information comprises the magnitude and direction of acceleration, and the second speed information comprises the magnitude and direction of a speed.

Certainly, in some embodiments, corresponding to the first movement information, the second movement information may only comprise the second acceleration information. Alternatively, in addition to the second acceleration information, the second movement information further comprises one of the second speed information and the second posture information.

In this embodiment of the present application, when the processing module 220 determines the second movement information according to the first movement information, the second movement information may be determined to be the same as the first movement information, increased or decreased in proportion with respect to the first movement information, or increased or decreased by a constant or variable with respect to the first movement information, that is, the processing module 220 may determine the relationship between the second movement information and the first movement information according to design requirements of the virtual scene; refer to corresponding description in the foregoing method embodiment for details.

In one example embodiment, the environment of the virtual scene is unchanged, and only movement of the virtual mobile carrier changes. In another example embodiment, when the second movement information of the virtual movement carrier changes, the virtual scene also is to change correspondingly, so as to bring about more realistic experience to the user. The apparatus 200 comprises:

a scene determining module 270, configured to determine scene information of the virtual scene corresponding to the second movement information.

Refer the corresponding description in the forgoing method embodiment for specific implementation of the function of the scene determining module 270, which is not repeated herein.

Optionally, as shown in FIG. 3b, in another possible implementation, in order to introduce a state parameter of the user with respect to the mobile carrier to the determining of the virtual scene so as to bring about more realistic entertainment experience to the user, the apparatus 200 further comprises:

a state information acquiring module 230, configured to acquire state information of the at least one user with respect to the mobile carrier.

Optionally, the state information acquiring module 230 comprises:

a first acquiring unit 231, configured to acquire posture information of the at least one user with respect to the mobile carrier; and

a second acquiring unit 232, configured to acquire safety belt usage information of the user.

Certainly, in other example embodiments, the state information acquiring module 230 may only comprise the first acquiring unit 231, or only comprise the second acquiring unit 232, or may further comprise another acquiring unit, configured to acquire other state information that can serve as reference.

Herein, the state information may comprise: posture information and/or safety belt usage information. The posture information, for example, may be: the posture information indicating that the user stands, sits or lies in the mobile carrier. For example, when the user stands in a compartment of a car, the character of the user may also stand in the virtual mobile carrier. In addition, for example, when the user uses the safety belt, the character of the user may also use the safety belt in the virtual mobile carrier.

In this example embodiment, the apparatus 200 comprises:

a scene determining module 280, configured to determine scene information of the virtual scene corresponding to the state information and the second movement information.

In the embodiment of the present application, the scene information comprises:

display information and sound information.

For example, when the mobile carrier suddenly brakes, the virtual mobile carrier may also suddenly brake in the virtual scene, and an environmental scene where a rock falls may appear in front of the virtual mobile carrier, and in addition, there may be sound corresponding to the sudden braking and the falling of the rock.

In one example embodiment, as shown in FIG. 3a, the apparatus 200 further comprises:

a presentation module 240, configured to present the virtual scene according to the scene information.

For example, the presentation module 240 may comprise a display screen, configured to display visual content in the virtual scene; in addition, the presentation module 240 may further comprise a loudspeaker, configured to play audio content in the virtual scene.

Certainly, in another example embodiment, the apparatus 200 does not comprise a presentation module, or a presentation effect of a presentation module of the apparatus 200 is unsatisfactory; therefore, the virtual scene may be presented by a presentation module of another device, and in this example embodiment, as shown in FIG. 3b, the apparatus 200 further comprises:

a first communication module 250, configured to provide the determined virtual scene to at least one external device.

For example, the apparatus 200 may be a smart phone of the user, which, after the scene information is determined, provides the scene information to another presentation device of the user, for example, smart glasses of the user, and the smart glasses present the virtual scene for the user.

In a further example embodiment, as shown in FIG. 3c, the apparatus 200 of this embodiment of the present application is only used for acquiring the second movement information, while determining and presentation of the virtual scene are performed by other devices, and in this example embodiment, the apparatus 200 further comprises:

a second communication module 260, configured to provide the second movement information to at least one external device.

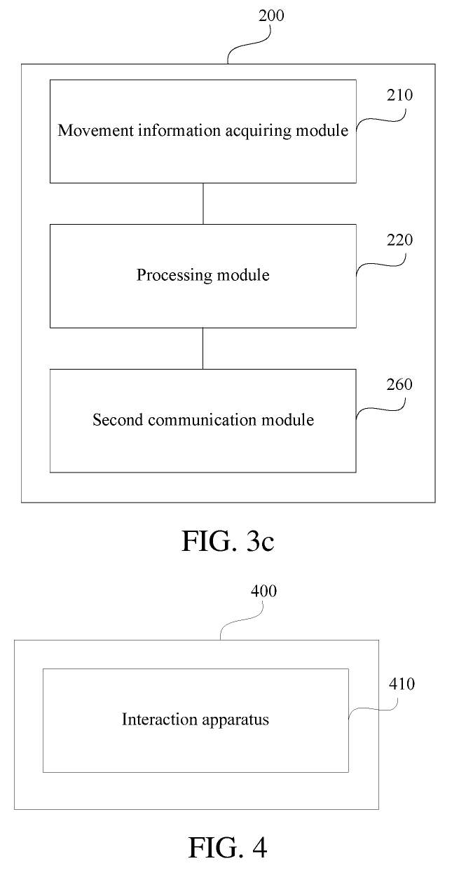

As shown in FIG. 4, an embodiment of the present application provides a user equipment 400, comprising the interaction apparatus 410 in the foregoing embodiment.

In one example embodiment, the user equipment is a smart near-to-eye display device, such as smart glasses or a smart helmet.

In another example embodiment, the user equipment is a mobile phone, a tablet computer, a notebook or another portable device.

Certainly, a person skilled in the art can know that, in addition to the user equipment 400, in one example embodiment, the interaction apparatus may also be disposed on the mobile carrier, for example, the interaction apparatus is a vehicle-mounted entertainment device.

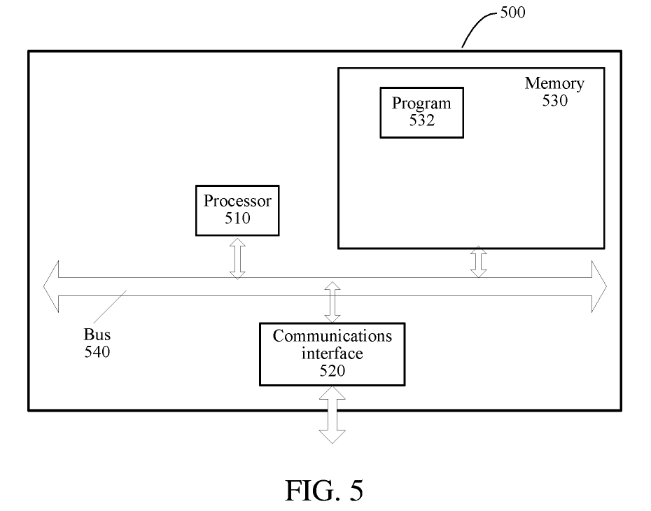

FIG. 5 is a structural schematic view of another interaction apparatus 500 according to an embodiment of the present application, and the specific embodiment of the present application does not limit specific implementation of the interaction apparatus 500. As shown in FIG. 5, the interaction apparatus 500 may comprise:

a processor 510, a communications interface 520, a memory 530, and a communications bus 540.

The processor 510, the communications interface 520, and the memory 530 communicate with each other through the communications bus 540.

The communications interface 520 is configured to communicate with a network element such as a client.

The processor 510 is configured to execute a program 532, and specifically, may implement relevant steps in the foregoing method embodiment.

Specifically, the program 532 may comprise program code, the program code comprising a computer operation instruction.

The processor 510 may be a central processing unit (CPU), or an application specific integrated circuit (ASIC), or be configured as one or more integrated circuits for implementing the embodiments of the present application.

The memory 530 is configured to store the program 532. The memory 530 may comprise a high-speed random access memory (RAM), and may also comprise a non-volatile memory, for example, at least one magnetic disk memory. The program 532 may be specifically configured to cause the interaction apparatus 500 to perform the following steps:

acquiring first movement information of a mobile carrier that at least one user rides on; and

determining, in real time according to the first movement information, second movement information of a virtual mobile carrier that at least one character corresponding to the at least one user in a virtual scene rides on.

Reference may be made to corresponding description of the corresponding steps and units in the foregoing embodiments for specific implementation of the steps in the program 532, which is not repeated herein. A person skilled in the art can clearly understand that, to make the description easy and concise, for the specific working process of the device and modules described above, reference may be made to the corresponding process description in the foregoing method embodiment, and will not be repeated herein.

It can be appreciated by a person of ordinary skill in the art that each exemplary unit and method step described with reference to the embodiments disclosed herein can be implemented by electronic hardware or a combination of computer software and electronic hardware. Whether these functions are executed by means of hardware or software depends on particular applications and design constraint conditions of the technical solution. For each particular application, the professional technicians can use different methods to implement the functions described, but such implementation should not be considered as beyond the scope of the present application.

When implemented in the form of software functional units and sold or used as an independent product, the functions may be stored in a computer-readable storage medium. Based on such understanding, the technical solution of the present application essentially or the part which contributes to the prior art or a part of the technical solution may be embodied in the form of a software product, and the computer software product is stored in a storage medium, and comprises several instructions for enabling a computer device (which may be a personal computer, a server, or a network device) to execute all or some steps of the method described in each embodiment of the present application. The foregoing storage medium comprises various media capable of storing program code, such as a USB disk, a removable hard disk, a read-only memory (ROM), a RAM, a magnetic disk, and an optical disc.

The above example embodiments are only used to describe the present application rather than to limit the present application; a person of ordinary skill in the art may make various changes and variations without departing from the spirit and scope of the present application. Therefore, all equivalent technical solutions also belong to the scope of the present application, and the patent protection scope of the present application should be subject to the claims.

What is claimed is:

1. A method, comprising:
acquiring, by a system comprising a processor, first movement information of a mobile carrier on which at least one user rides; and
determining, in response to the acquiring the first movement information, second movement information of a virtual mobile carrier on which at least one character corresponding to the at least one user in a virtual scene rides.

2. The method of claim 1, wherein the first movement information comprises: first acceleration information.

3. The method of claim 2, wherein the first movement information further comprises at least one of:
first speed information or first posture information.

4. The method of claim 1, wherein the acquiring the first movement information comprises:
collecting the first movement information.

5. The method of claim 1, wherein the acquiring the first movement information comprises:
receiving the first movement information from at least one external device.

6. The method of claim 1, wherein the second movement information comprises: second acceleration information.

7. The method of claim 6, wherein the second movement information further comprises at least one of:
second speed information or second posture information.

8. The method of claim 1, further comprising:
determining scene information of the virtual scene corresponding to the second movement information.

9. The method of claim 1, further comprising:
acquiring state information of the at least one user with respect to the mobile carrier.

10. The method of claim 9, wherein the state information comprises at least one of: posture information or safety belt usage information.

11. The method of claim 9, further comprising:
determining scene information of the virtual scene corresponding to the state information and the second movement information.

12. The method of claim 8, wherein the scene information comprises:
display information and sound information.

13. The method of claim 8, further comprising:
providing the scene information to at least one external device.

14. The method of claim 8, further comprising:
presenting the virtual scene according to the scene information.

15. The method of claim 1, further comprising:
providing the second movement information to at least one external device

16. The method of claim 1, wherein the virtual scene is an immersive virtual scene.

17. The method of claim 1, wherein the virtual scene is a game scene.

18. An apparatus, comprising:
a memory that stores executable modules; and
a processor, coupled to the memory, that executes or facilitates execution of the executable modules, comprising:
a movement information acquiring module configured to acquire first movement information of a mobile carrier on which at least one user rides; and
a processing module configured to determine, according to the first movement information, second movement information of a virtual mobile carrier on which at least one character corresponding to the at least one user in a virtual scene rides.

19. The apparatus of claim 18, wherein the first movement information comprises: first acceleration information.

20. The apparatus of claim 19, wherein the first movement information comprises at least one of:
first speed information or first posture information.

21. The apparatus of claim 18, wherein the movement information acquiring module comprises:
a movement information collecting unit configured to collect the first movement information.

22. The apparatus of claim 18, wherein the movement information acquiring module comprises:
a communication unit configured to receive the first movement information from at least one external device.

23. The apparatus of claim 18, wherein the second movement information comprises: second acceleration information.

24. The apparatus of claim 23, wherein the second movement information further comprises at least one of:
second speed information or second posture information.

25. The apparatus of claim 18, wherein the executable modules further comprise:
a scene determining module configured to determine scene information of the virtual scene corresponding to the second movement information.

26. The apparatus of claim 18, wherein the executable modules further comprise:
a state information acquiring module configured to acquire state information of the at least one user with respect to the mobile carrier.

27. The apparatus of claim 26, wherein the state information acquiring module comprises at least one of:
a first acquiring unit configured to acquire posture information of the at least one user with respect to the mobile carrier; or
a second acquiring unit configured to acquire safety belt usage information of the user.

28. The apparatus of claim 26, wherein the executable modules further comprise:
a scene determining module configured to determine scene information of the virtual scene corresponding to the state information and the second movement information.

29. The apparatus of claim 25, wherein the executable modules further comprise:
a first communication module configured to provide the scene information to at least one external device.

30. The apparatus of claim 25, wherein the executable modules further comprise:
a presentation module configured to present the virtual scene according to the scene information.

31. The apparatus of claim 18, wherein the executable modules further comprise:
a second communication module configured to provide the second movement information to at least one external device.

32. The apparatus of claim 18, wherein a user equipment comprises the apparatus.

33. The apparatus of claim 32, wherein the user equipment comprises a smart near-to-eye display device.

34. A computer readable storage device comprising executable instructions that, in response to execution, cause a device comprising a processor to perform operations, comprising:
acquiring first movement information of a mobile carrier on which at least one user rides; and
determining, in response to the acquiring the first movement information, second movement information of a virtual mobile carrier on which at least one character corresponding to the at least one user in a virtual scene rides.
